(19) United States
(12) Patent Application Publication
(10) Pub. No.: US 2016/0341147 A1
(43) Pub. Date: Nov. 24, 2016

(54) PISTON TOP PROVIDING STRUCTURAL UNIT

(71) Applicant: Caterpillar Motoren GmbH & Co. KG, Kiel (DE)

(72) Inventors: Sascha BURKHARD, Kronshagen (DE); Dirk MOOSER, Schwentinental (DE); Ingo LANGSCHWAGER, Stade (DE); Eike Joachim SIXEL, Kiel (DE); Kai RUSCHMEYER, Fintel (DE); Marius WOLFGRAMM, Kiel (DE); Hendrik Johannes LANGE, Kiel (DE); Michael STURM, Neuwittenbek (DE)

(73) Assignee: Caterpillar Motoren GmbH & Co. KG, Kiel (DE)

(21) Appl. No.: 15/159,988

(22) Filed: May 20, 2016

(30) Foreign Application Priority Data
May 22, 2015 (DE) 102015006642.0

(51) Int. Cl. F02F 3/24; F02F 3/16; F02F 3/00

(52) U.S. Cl. CPC F02F 3/24; F02F 3/0015; F02F 3/16

(57) ABSTRACT

A piston top structural unit for an internal combustion engine may include a piston crown structure providing a top surface and a peripheral surface, wherein, regarding a center axis of the piston, the top surface is configured to delimit the piston top structural unit axially with respect to a combustion chamber of the internal combustion engine and the peripheral surface is configured to delimit the piston top structural unit radially. The top surface may include a rim surface extending around the center axis, and an inner surface delimiting a piston bowl radially within the peripheral surface. The inner surface may include an area of lowest positions of the piston bowl, a first side wall surface extending essentially along the direction of the center axis from a first border section of the area of the lowest positions to the rim surface, a deflecting bottom surface raising from a second border section of the area of the lowest positions to form an asymmetric piston bowl bottom, and at least one second side wall surface extending essentially along the direction of the center axis from a respective border section of the deflecting bottom surface to the rim surface. The asymmetric shape may allow the generation of a tumble flow of charged air for improving ignition.

### CLAIM FOR PRIORITY

This application claims the benefit of priority under 35 U.S.C. §119(a) of German Patent Application No. 10 2015 006 642.0, filed May 22, 2015, which is incorporated herein in its entirety by reference.

### TECHNICAL FIELD

The present disclosure relates to a piston for internal combustion engines, and in particular to a flow affecting piston top configuration for flow dynamic adjusted internal combustion engines.

### BACKGROUND

Internal combustion engines can emit harmful oxides of nitrogen (“NOx”) during operation. Those oxides form when nitrogen and oxygen, both of which are present in the charge air used for combustion, react within the main combustion chamber. Typically, the level of NOx formed increases as the peak combustion temperatures within the combustion chambers increase. As such, minimizing the peak combustion temperatures within the main combustion chamber generally reduces the emission of NOx.

For example, leaner charge air-gaseous fuel mixtures may be used in gaseous fuel operated internal combustion engines to reduce the peak combustion temperatures in the main combustion chamber, thus they may reduce the amount of harmful NOx emitted. Although a lean charge air-gaseous fuel mixture may—due to its relatively large air-to-fuel ratio when compared to a gas mixture having a stoichiometric air-to-fuel ratio by using more air in the mixture—advantageously lower NOx emissions, it also may result in an incomplete combustion within the main combustion chamber and a poor ignitability of the charge air-gaseous fuel mixture.

In general, pre-combustion chamber systems may be used to minimize the occurrence of incomplete combustion. In general, a pre-combustion chamber is in fluid communication with the main combustion chamber of the internal combustion engine via small flow transfer passages. Ignition of the fuel within the pre-combustion chamber creates a flame front of burning fuel that is jetted through the flow transfer passages into the main combustion chamber, where respective ignition jets ignite the lean charge air-gaseous fuel mixture within the main combustion chamber.

Although the flame front of burning ignition jets may generally be sufficient to cause complete combustion of the lean charge air-gaseous fuel mixture within the main combustion chamber, in general the enriched pre-chambers itself may produce a large amount of NOx-emissions caused by the stoichiometric or under stoichiometric combustion within the pre-combustion chamber.

Similar considerations apply to liquid fuel operated internal combustion engines using fuel injectors for injecting fuel jets into the combustion chamber.

In particular for medium speed internal combustion engines, features of a piston assembly include the piston itself with a piston top structural unit and a piston skirt structural unit, one or more piston rings mounted to ring grooves provided, for example, at the outer surface of the piston top structural unit and separated by ring lands, and a piston pin bore for mounting the piston to a piston rod via a piston pin. The piston top comprises a top surface (closest to the cylinder head) of the piston.

The piston reciprocally moves within a cylinder or a cylinder liner between a top dead center position (TDC) and a bottom dead center position (BDC), delimiting thereby the combustion chamber. During engine operation, the piston top surface is subjected to the combustion process and the respectively generated heat.

In medium speed four stroke combustion engines, the piston top may comprise a crown structure surrounding a piston bowl. Due to the crown structure, the top surface comprises a rim surface that approaches an opposite cylinder head surface as close as possible at TDC of the piston to reduce the volume not subjected to the combustion. Thereby, any wasted volume is avoided or at least reduced. The top surface further comprises an inner surface of the piston bowl. The inner surface comprises sidewall surfaces extending along the crown structure and a bottom surface at the bottom of the bowl.

At TDC, the piston bowl delimits together with the respective portion of the cylinder head face essentially the combustion chamber at its minimum size.

In general, medium speed four stroke internal combustion engines may be operated with a liquid fuel, such as Diesel oil or heavy fuel oil, and with a gaseous fuel, such as natural gas. Furthermore, medium speed dual fuel engines are known that run on either liquid fuel or on gaseous fuel. During a respective liquid fuel operation, liquid fuel is provided to the combustion chamber—for example via an ignition nozzle—prior TDC to form a fuel air mixture. The fuel air mixture may be self-igniting or may be ignited by a spark plug. During a respective gaseous fuel operation, the charge air-gaseous fuel mixture may be ignited by injecting an ignition amount of a liquid fuel such as Diesel fuel, which then ignites due to the pressure within the combustion engine. Alternatively, as mentioned above a pre-combustion chamber configuration allows igniting a small amount of the combustion mixture within a pre-combustion chamber and releasing the ignited mixture into the (main) combustion chamber.

In general, it is a task to provide for a combustion process that is well defined and uses, for example, all or at least most of the fuel. In particular the starting phase of the combustion effects the combustion process in this respect.

The present disclosure is directed, at least in part, to improving or overcoming one or more aspects of prior systems.

### SUMMARY OF THE DISCLOSURE

According to an aspect of the present disclosure, a piston top structural unit for a piston of an internal combustion engine comprises a piston crown structure providing a top surface and a peripheral surface of the piston top structural unit, wherein, regarding a center axis of the piston, the top surface is configured to delimit the piston top structural unit axially with respect to a combustion chamber of the internal combustion engine and the peripheral surface is configured to delimit the piston top structural unit radially. Moreover, the top surface comprises a rim surface extending around the center axis, and an inner surface delimiting a piston bowl radially within the peripheral surface. The inner surface comprises an area of lowest positions of the piston bowl, a first side wall surface extending essentially along the direction of the center axis from a first border section of the area of the lowest positions to the rim surface, a deflecting bottom surface raising from a second border section of the area of the lowest positions to form an asymmetric piston bowl bottom, and at least one second side wall surface extending essentially along the direction of the center axis from a respective border section of the deflecting bottom surface to the rim surface.

According to another aspect of the present disclosure, an internal combustion engine comprises a cylinder unit, at least one inlet valve associated with the cylinder unit, at least one outlet valve associated with the cylinder unit, and a piston arranged within the cylinder unit and having a piston top structural unit as described above and a piston skirt unit.

Other features and aspects of this disclosure will be apparent from the following description and the accompanying drawings.

### BRIEF DESCRIPTION OF THE DRAWINGS

The accompanying drawings, which are incorporated herein and constitute a part of the specification, illustrate exemplary embodiments of the disclosure and, together with the description, serve to explain the principles of the disclosure. In the drawings:

FIG. 1 shows a top view of a first exemplary configuration of a piston for an internal combustion engine;

FIG. 2 shows a side view of the piston of FIG. 1;

FIG. 3 shows a top view of a second exemplary configuration of a piston for an internal combustion engine;

FIG. 4 shows a side view of the piston of FIG. 3;

FIG. 5 shows a side view of a third exemplary configuration of a piston for an internal combustion engine;

FIG. 6 shows a sectional view of a first exemplary configuration of a cylinder unit for generating a tumble flow prior TDC;

FIG. 7 shows a sectional view of a second exemplary configuration of a cylinder unit for generating a tumble flow at TDC;

FIG. 8 shows a sectional view of a first exemplary configuration of a cooling configuration of a piston with an asymmetric raising bowl bottom; and

FIG. 9 shows a sectional view of a second exemplary configuration of a cooling configuration of a piston with an asymmetric raising bowl bottom.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure may be based at least in part on the realization that providing an asymmetric raising bowl bottom of a piston bowl may support a more efficient combustion, in particular by initiating the combustion over a large volume portion of the combustion chamber. Moreover, it was realized that such an asymmetric raising bowl bottom may improve mixing of the combustion mixture or charge air with ignition jets or liquid fuel jets.

Furthermore, it was realized that implementing an asymmetric raising bowl bottom in a piston for a medium to large internal combustion engine, e.g. in pistons having diameters in the range from 180 mm to 600 mm, may further allow for providing a compensated cooling of the bowl bottom, a balanced weight of the piston, and/or stiff structure due to the large dimensions as those may allow providing for an asymmetric structure, in particular cooling structure.

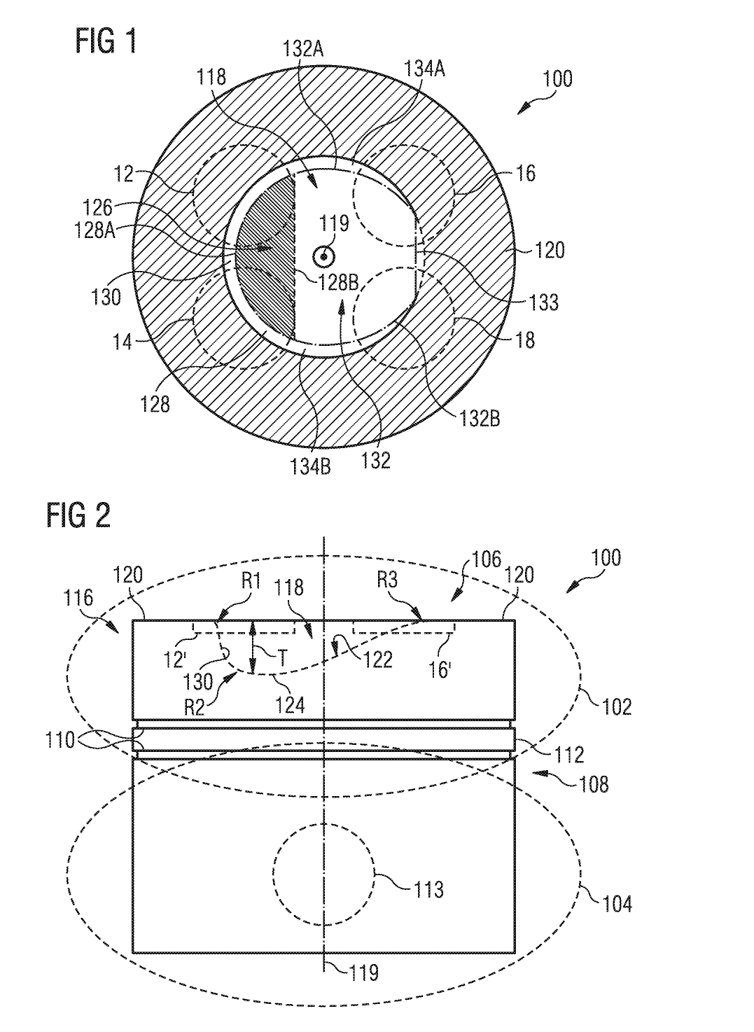

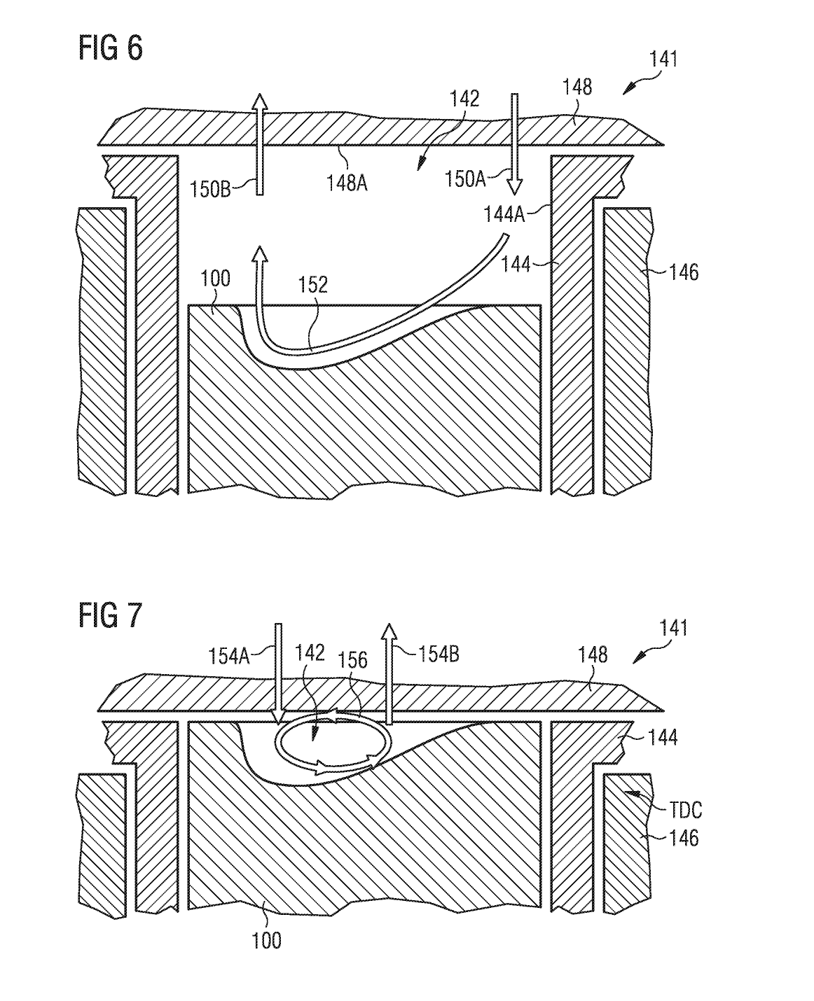

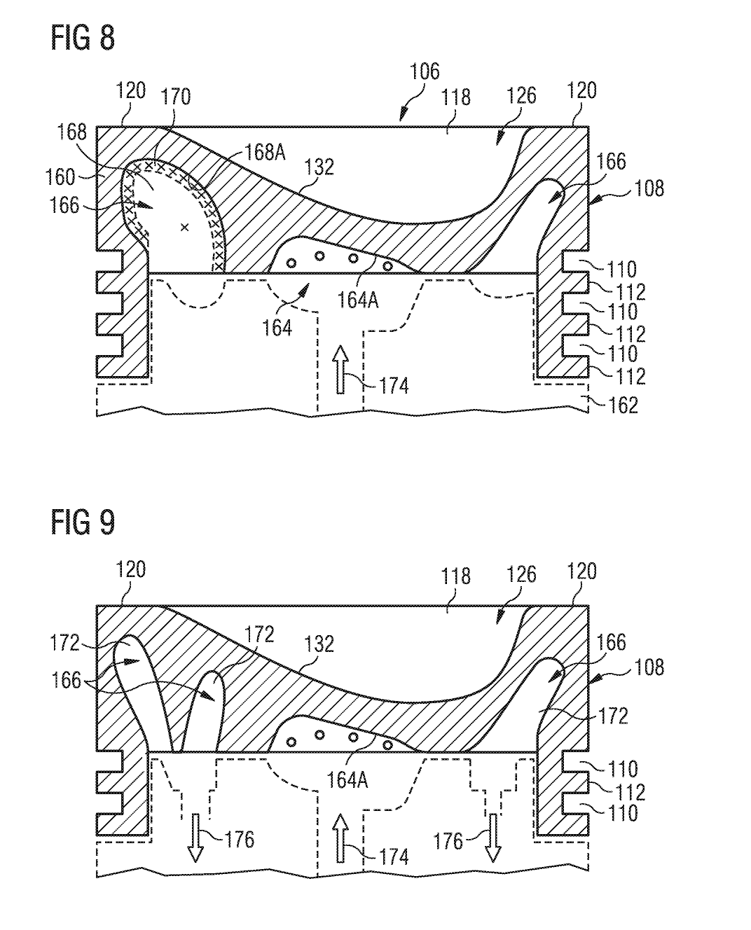

In the following, various exemplary configurations of an asymmetric raising bowl bottom of a piston for in particular medium to large internal combustion engines are explained in particular in connection with FIGS. 1 to 6. In connection with FIGS. 6 and 7, the potential generation of a tumble flow in a combustion chamber by the use of such an asymmetric raising bowl bottom is described. FIGS. 8 and 9 relate to cooling configurations. In the various drawings, the same reference numerals may be used for the same or similar structural components or sections, for simplifying the understanding.

FIGS. 1 and 2 show respectively a top view and a side view of a first configuration of a piston for an internal combustion engine. Specifically, FIG. 1 illustrate an exemplary piston 100 for a piston assembly of an internal combustion engine. Mounted within a cylinder unit (see also FIGS. 6 and 7), piston 100 delimits together with an opposing section of a cylinder head and the inner side walls of, for example, a cylinder liner a combustion chamber. Repeatedly driven by the combustion within the combustion chamber, piston 100 reciprocally moves within the cylinder (or a cylinder liner) between TDC and BDC.

For instance, the internal combustion engine may be a gaseous fuel Otto engine, a Diesel engine, a dual fuel engine operably with liquid fuel and gaseous fuel, or a multi fuel engine operable with, for example, heavy fuel oil, Diesel fuel, gaseous fuel, and/or alternative fuels.

As in particular illustrated in FIG. 2, piston 100 includes a piston top structural unit 102 and a piston skirt structural unit 104. A top surface 106 of piston top structural unit 102 delimits the combustion chamber, while a peripheral surface 108 of piston top structural unit 102 (and piston skirt structural unit 104) may in general provide for sealing with respect to and guidance along the inner surface of the liner. Usually, due to the cylinder shape of piston 100, also piston top structural unit 102 and piston skirt structural unit 104 have a peripheral surface 108 that is cylinder jacket shaped.

In some embodiments, piston top structural unit 102 and piston skirt structural unit 104 may be formed as separate parts, usually referred to as piston top and piston skirt. The piston top and the piston skirt may be bolted together to allow for replacing usually the piston top, which is subject to the combustion process with its high temperatures and chemically active combustion gases. In some embodiments, piston top structural unit 102 and piston skirt structural unit 104 may be formed as a single part.

In some embodiments, piston 100 may provide ring grooves 110 for mounting piston rings (not shown) to ensure, for example, proper sealing of the combustion chamber. As shown in FIG. 2, ring grooves 110 may be provided, for example, at the transition between piston top structural unit 102 and piston skirt structural unit 104 and are separated by ring lands 112.

Moreover, piston 100 allows attaching piston 100 to a piston rod via bearing 113 for mounting a piston pin to drive a crankshaft (not shown).

For coolant based cooling of piston 100, the coolant such as oil may be guided, for example, via the piston rod to the inside of piston 100. There, the coolant may be distributed to a coolant guiding structure (not shown), in which the coolant receives the heat from those portions of piston top structural unit 102 that are subject to the heat generated by the combustion process. The coolant guiding structure is at least partly integrated into the piston top structural unit 102 and may further be partly integrated into the piston skirt structural unit 104.

Exemplary cooling guiding structures are described below in connection with FIGS. 8 and 9. In general, a coolant guiding structure may be configured as a channel system having the coolant such as oil propagate there through and/or comprise drilled holes (so called shaker chambers/room), in which the coolant shakes up and down during the reciprocation of piston 100. The channel system is further configured to return the oil to the main cooling oil system (not shown).

In particular for medium speed four stroke engines, piston top structural unit 102 comprises a crown structure 116 that is shaped to form top surface 106 and defines a piston bowl 118 therein. The herein disclosed concepts for the shape of the top surface 106 in particular may affect the flow within the combustion chamber.

As shown in FIG. 2, crown structure 116 extends around a center axis 119. Herein, as understood by the skilled reader, an axial orientation usually refers to center axis 119.

Due to crown-like shape of crown structure 116, top surface 102A comprises a rim surface 120 surrounding piston bowl 118 usually in a circular manner and coaxially with respect to center axis 119. During operation of the internal combustion engine, rim surface 120 approaches an opposite cylinder head surface as close as possible at TDC to reduce the volume not subjected to the combustion. Thereby, wasted volume is avoided or at least reduced and the compression ratio can further be increased for large piston diameters.

At TDC, piston bowl 118 forms together with the respective portion of the opposing cylinder head face the combustion chamber when it has its minimum size (see also FIG. 8).

Top surface 106 further comprises an inner surface of piston bowl 118. Inner surface comprises generally axially extending sidewall sections forming the crown-like shape with the rim structure and a bottom section forming a bowl bottom 122 of piston bowl 118.

The herein disclosed concepts are based on an asymmetrical raising bowl bottom 122 as schematically indicated by a dashed line in FIG. 2. In connection with the following figures, exemplary shapes of piston bowl 118 and bowl bottom 122 are disclosed that allow, for example, the formation of a specific tumble flow of the charge air fuel mixture within the combustion chamber during the reciprocation. The tumble flow may be configured to result in a combustion process that reaches essentially the complete or an increased amount of the charge air fuel mixture at a desired temporal behavior. This may in particular be possible due to specific configurations of ignition jets or liquid fuel jets as well as the orientation with respect to inlet and outlet valves as disclosed, for example, in the European patent application entitled “COUNTER FLOW IGNITION IN INTERNAL COMBUSTION ENGINES” and filed by the applicant on the same day.

Referring again to FIGS. 1 and 2, piston bowl 118 has a depth T wherein the depth is defined from rim surface 120 to a lowest position 124 of piston bowl 118. In some embodiments, lowest position 124 may be present at an area 126 of lowest positions 124 as schematically shown in FIG. 2. For medium speed internal combustion engines, depth T may be in the range from, for example, about 5 mm to about 50 mm, in particular, for large internal combustion engines, depth T may be in the range from about 25 mm to about 50 mm.

As illustrated in the exemplary embodiment of FIG. 1, piston 100 is used in an internal combustion engine that has two inlet valves 12, 14 and two outlet valves 16, 18 per cylinder. The valves may be poppet valves and exemplary positions of the valves are indicated with dashed circles in FIG. 1. In general, the internal combustion engine may include more or less inlet and outlet valves.

As shown in FIG. 1, area 126 of lowest positions 124 is at the side of inlet valves 12, 14 (see also the description in connection with FIG. 8). In another orientation of the valves, area 126 of lowest positions 124 is at the side of outlet valves 16, 18 with respect to the piston (see also the description in connection with FIG. 7). As will be apparent to the skilled person, those orientations will—for example, also in combination with respect to valve timings—affect the flow within the combustion chamber.

In some configurations, top surface 106 may include for those valves respective valve seat pockets. In FIG. 2, exemplary valve pockets 12′ and 16′ are schematically indicated for inlet valve 12 and outlet valve 16, respectively. A valve seat pocket usually is configured to, when piston 100 is at TDC, at least partially accommodate an associated valve disk (not shown).

Area 126 of lowest positions 124 may extend essentially orthogonal with respect to center axis 119 and may form one portion of inner surface 122 of piston bowl 118 as indicated in FIG. 1. In general, area 126 of lowest positions 124 is asymmetrically arranged with respect to center axis 119.

Area 126 can be associated with a border line 128 shown as a dash dotted line in FIG. 1. At a first section 128A of border line 128, area 126 is connected to rim surface 120 via a first (axial) side wall surface 130 that extends essentially along the direction of center axis 119. In this context, essentially means that the orientation of first (axial) side wall surface 130 is within an angular range from 0° to 50° such as in the range from 10° to 40° with respect to center axis 119 or even in an undercut-like manner (at least section-wise having angles in the range from, e.g. −40° to 0°. The transitions between rim surface 120 and first (axial) side wall surface 130 as well as the transition between side wall surface 130 and area 126 may be smoothed by providing some curvatures with a radius (indicated as radii R1, R2 respectively in FIG. 2) in the range from, for example, 1 mm to about 50 mm at the transitions. In general, radius R2 may be larger (e.g. in the range from 4 mm to 15 mm) than radius R1 (e.g. in the range from, e.g. 20 mm to 50 mm).

At a second section 128B of border line 128, area 126 is connected to rim surface 120 via a deflecting bottom surface 132. As shown in the side view of FIG. 2, deflecting bottom surface 132 is inclined with respect to center axis 119. Deflecting bottom surface 132 may be, for example, planar or slightly curved.

In the embodiment shown in FIGS. 1 and 2, deflecting bottom surface 132 extends axially up to the height of rim surface 120 and may smoothly transition into the same with some curvature radius R3 in the range from, for example, 5 mm to 30 mm. Accordingly, rim surface 120 is extended towards center axis 119 resulting in a linearly extending transition (dashed line 133 in FIG. 1) with respect to deflecting bottom surface 132.

As further indicated in FIG. 1 by double dashed dotted lines 132A and 132B, deflecting bottom surface 132 is connected at the sides to rim surface 120 via second axial side wall surfaces 134A, 134B. As for first side wall surface 130, second (axial) side wall surfaces 134 may extend essentially along the direction of center axis 119 and the transitions between rim surface 120 and respective second side wall surfaces 134 may be smoothed by curvature radii provided in the range from 5 mm to 30 mm at the transitions.

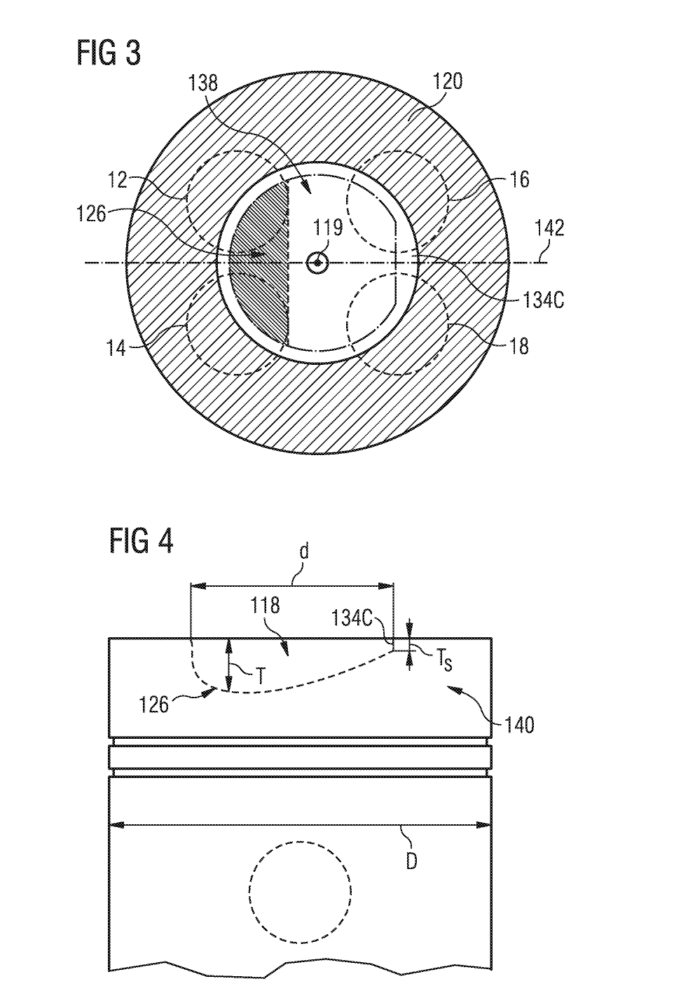

As will be understood by the skilled person, various aspects and considerations described in detail will also be apply generally to the herein disclosed concepts despite being disclosed or mentioned only with respect to a specific configuration to not overload the respective drawings and avoid repetitive disclosure. For example, aspects such as curvature radius size of the deflecting bottom surface, and cooling described for FIGS. 1 and 2 as well as FIGS. 8 and 9 will equally be applicable to the configurations described in connection with FIGS. 3 to 6. Similarly, various aspects and considerations described in connection with FIGS. 3 to 6 will be applicable to the configuration described in connection with, for example, FIGS. 1 and 2.

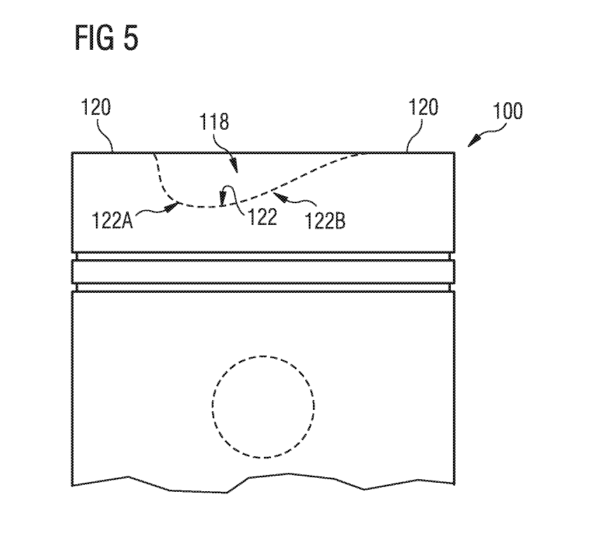

Referring to FIGS. 3 and 4, a further embodiment of piston 100 is illustrated in which the extent of deflecting bottom surface 132 is modified with respect to the axial extension as well as the radial extension.

In FIG. 3 an opening area 138 of piston bowl 118 is indicated, which is surrounded by rim surface 120. A respective diameter d is illustrated in FIG. 4 as well as a diameter D of piston 100. For medium speed large internal combustion engines, the diameter d of opening area 138 of piston bowl 118 may be in the range from about, for example, 50 mm to about, for example, 550 mm, in particular from about 100 mm to about 450 mm, and diameter D of piston 100 may be in the range from about, for example, about 180 mm to about 600 mm, in particular from about 200 mm to about 500 mm. For example, a ratio of diameter d of opening area 138 with respect to diameter D may be in the range from, for instance, about 0.3 to about 0.8.

Area 126 may have a size (in radial extension) that may be up to, for example, about 50% of the opening area 138. Correspondingly, a size of deflecting bottom surface 132 may extend from about 20% up to 100%. Thus, deflecting bottom surface 132 may extend essentially over the complete opening area 138, resulting in a line or even point like extension of area 126 as a minimum. In particular, the extension of deflecting bottom surface 132 from area 126 to rim surface 120 may be in the range from about 40% to about 100% of opening area 138. Respectively, the extension in radial direction along the raising direction is in the range from about 40% to about 100% of diameter d of opening area 138.

A ratio of depth T of piston bowl 118 with respect to diameter D of piston 100 may be in the range from, for example, about 0.03 to about 0.2, wherein diameter D may be in the range from, for example, about 180 mm to about 500 mm.

Exemplarily, the configuration is shown in FIG. 4 with area 126 to be about 5% of opening area 138. Moreover, the configuration is shown without any valve pockets. Moreover, in the configuration of FIGS. 3 and 4, piston bowl 118 may comprise a circumferentially extending side wall section such that there forms a step 140. Accordingly, a third axial side wall surface 134C (facing towards first side wall surface 130) is indicated in FIGS. 3 and 4. A height Ts of step 140 may be in the range from 10% to 50% of height T of piston bowl 118.

Third axial side wall surface 134C of step 140 may transition into rim surface 120 and deflecting bottom surface 132 with respective radius values as discussed above, for example, in connection with first (axial) side wall surface 130.

In FIG. 5, an essentially continuously curved bowl bottom 122 is shown, having a region 122A of larger curvature forming area 126 and a region 122B of smaller curvature forming essentially deflecting bottom surface 132. Besides the curved deflecting bottom surface 132, the configuration may be similar to the one shown in FIGS. 1 and 2. Providing a continuously curved bowl bottom allows smoothly deflecting, for example, incoming charge air to form a tumble flow. Respective transitions at side walls or rim surface 120 may be smoothed again by respective curvature radii.

Moreover, the exemplary configurations shown in FIGS. 1, 3 and 5 may have piston bowls 118 that are mirror symmetric. For example in FIG. 3, a mirror axis 142 is illustrated as the symmetry line for the pairs of inlet valves 12, 14 and outlet valves 16, 18. In other words, mirror axis 142 runs orthogonally to the linearly arranged inlet valves (linearly arranged outlet valves) through center axis 119. However, depending on valve configurations also non-mirror symmetric configurations may be considered by the skilled person.

Referring to FIGS. 6 and 7, the generation of, for example, a tumble flow is illustrated for an asymmetric piston that accordingly has sides differing in geometry. In general, inlet valves may be arranged at one side of the asymmetric piston and outlet valves may be arranged at the opposite side of the asymmetric piston. Then, the asymmetric shape of specifically the piston bowl allows mounting the piston with respect to the valves such that, for example, charge air will enter the combustion chamber at the side of the deflecting bottom surface. A respective configuration is shown in FIG. 6. Similarly, the piston may be mounted such that, for example, charge air will enter the combustion chamber at the side of the area of deepest depth of piston bowl as illustrated in FIG. 7.

FIG. 6 illustrates a cylinder unit 141 of an internal combustion engine, where a position of piston 100 is illustrated at the time of charging a combustion chamber 143, i.e. prior TDC. Combustion chamber 143 is delimited at the sides by an inner surface 144A of a cylinder liner 144 mounted to an engine block 146 of the internal combustion engine. In axial direction, combustion chamber 143 is delimited on one side by movable piston 100 and at the other side by a surface section 148A of a cylinder head 148.

In FIG. 6, the position of the charge air admission is indicated by an arrow 150A and the relief position of the exhaust is indicated by an arrow 150B.

As the charge air will encounter with the inclined surface of the asymmetric bowl bottom 122, the flow will be deflected towards area 126 of the lowest positions 124. Then it will be guided upwards along first (axial) side wall surface 130 as illustrated by an arrow 152. Accordingly, a tumble flow may form during the charging of combustion chamber 143 that even will be maintained until the ignition takes place.

FIG. 7 illustrates another orientation of piston 100 with respect to the valves. Specifically, cylinder unit 141 is depicted at a position of piston 100 at TDC. Combustion chamber 143 is then formed primarily by piston bowl 118, which is covered by a central section of surface section 148A of cylinder head 148. Rim surface 120 is very close to cylinder head 148, accordingly an extension of combustion chamber 143 above rim surface 120 may be neglected for the considerations herein.

As an example, the position of the charge air admission is indicated by an arrow 154A and the relief position of the exhaust is indicated by an arrow 154B, although the valves may be closed at TDC. Nevertheless, due to the orientation of the inlet valves with respect to asymmetric piston 100, a tumble flow is indicated by an arrow 156, which in this case tumbles in a rotation direction that is opposite to the one of FIG. 6.

Due to asymmetry of piston bowl 118 generated by the raising of deflecting bottom surface from the area of the lowest positions, various features of piston 100 may become asymmetric as well such as, for example, the required cooling geometry, the piston stiffness, and the weight distribution.

In connection with FIGS. 8 and 9, exemplary embodiments of cooling configurations are described. The configurations may additionally affect piston stiffness and weight distribution. For example, in FIGS. 8 and 9 potential weight balancing for the piston top structural unit is schematically applied. As will be apparent, for a mirror symmetric configurations, weight balancing may be performed primarily along the axis of the mirror symmetry. Additionally or alternatively, a respective weight balancing may be performed by adjusting the weight of the piston skirt structural unit. As further illustrated in FIG. 8, the stiffness of the asymmetric piston can be provided, for example, by introducing ribs within a cooling chamber.

Specifically, FIG. 8 shows a cut view of a piston top 160 attached to a piston skirt 162 of a two part piston. Piston top 160 corresponds to a piston top structural unit, while piston skirt 162 corresponds to piston skirt unit. Exemplarily, asymmetric piston bowl 118 is indicated, which at top surface 106 is surrounded by rim surface 120.

As can be seen in FIG. 8, the asymmetry of piston bowl across the cut plane results in different axial extension, which could be filled with material. In particular, at area 126, the distance to piston skirt 162 is smaller than at the raised portion of deflecting bottom surface 132. Accordingly, the heat dissipation may vary, as may the mass distribution and the stiffness.

As further can be seen in FIG. 8, a coolant guiding structure is partly integrated into piston top 160. Specifically, piston top 160 includes an inner cooling chamber surface 164A for forming an inner cooling chamber 164 that extends within the radial inner section of piston top 160. Inner cooling chamber surface 164A at least partly follows the inclination of deflecting bottom surface 132, thereby in particular providing—in at least some radial portion—a material thickness between inner cooling chamber surface 164A and deflecting bottom surface 132 that is essentially constant in thickness. Accordingly, the cooling efficiency in that radial portion is essentially comparable.

In FIG. 8, the coolant guiding structure comprises further a peripheral cooling volume 166. Usually, peripheral cooling volume 166 is fluidly connected via channels some of which are schematically indicated by channel openings 171 at inner cooling chamber surface 164A. As can be seen in FIGS. 8 and 9, peripheral cooling volume 166 is larger at the side where deflecting bottom surface 132 transitions into rim surface 120 than at the side where area 126 is located.

In the embodiment of FIG. 8, piston top 160 provides for a coolant guiding structure that comprises a peripheral cooling channel surface 168A for forming a peripheral cooling channel 168. Peripheral cooling channel 168 is larger and thus provides a larger cooling volume at the side where deflecting bottom surface 132 transitions into rim surface 120 than at the side where area 126 is located. As a consequence, a larger amount of material may be more efficiently cooled at the side where deflecting bottom surface 132 transitions into rim surface 120. Moreover, the weight may be at least partly balanced.

Furthermore, peripheral cooling channel 168 may be configured such that in particular peripheral cooling channel surface 168A may comprise one or more in particular radially extending rib structures 170 as schematically indicated in FIG. 8 for the side where deflecting bottom surface 132 transitions into rim surface 120. Similar rib structures may allow stabilizing inner cooling chamber 164.

In other words, piston top 106 (and generally a piston top structural unit) may comprise an asymmetric outer cooling channel to compensate for the asymmetry introduced by the asymmetric top surface 106. The compensation may relate to cooling efficiency, stability, and weight distribution.

In FIG. 9, an alternative coolant guiding structure is illustrated that is based on cooling bores 172 forming shaker chambers, in which coolant moves axially during engine operation as known in the art. In view of the asymmetric piston shape, cooling bores 172 may differ in size or number with respect to their azimuthal position regarding center axis 119.

For completeness, piston skirt 162 (and generally piston skirt structural unit 104) may be used for weight compensating a weight asymmetry introduced by the asymmetric piston bowl. For example, additional weight can be provided or material can be removed asymmetrical from piston skirt 162.

In some embodiments, peripheral cooling channel 168 may be extended with cooling bores 172.

As schematically indicated in FIGS. 8 and 9, during operation, oil as a coolant may be provided to inner cooling chamber 164 (arrow 174) and be than guided to peripheral cooling channel 168 from where it returns to the cooling system (arrow 176).

In some embodiments, a portion of outer cooling channel is at least partially disposed below rim surface 120 to at least partially cool the piston's top surface at the periphery.

### INDUSTRIAL APPLICABILITY

As has been explained in particular in connection with FIGS. 6 and 7, the herein disclosed concepts may allow generation of a tumble flow that in particular can be used to generate a counter flow ignition configuration, when operating an internal combustion engine.

As further has been explained, structural adaptations may be performed to provide for a weight/cooling/stiffness compensated piston.

Although the preferred embodiments of this invention have been described herein, improvements and modifications may be incorporated without departing from the scope of the following claims.

1. A piston top structural unit for a piston of an internal combustion engine, comprising:
a piston crown structure providing a top surface and a peripheral surface of the piston top structural unit, wherein, regarding a center axis of the piston, the top surface is configured to delimit the piston top structural unit axially with respect to a combustion chamber of the internal combustion engine and the peripheral surface is configured to delimit the piston top structural unit radially, wherein
the top surface comprises a rim surface extending around the center axis, and an inner surface delimiting a piston bowl radially within the peripheral surface, and the inner surface comprises
an area of lowest positions of the piston bowl,
a first side wall surface extending essentially along the direction of the center axis from a first border section of the area of the lowest positions to the rim surface,
a deflecting bottom surface raising from a second border section of the area of the lowest positions to form an asymmetric piston bowl bottom, and
at least one second side wall surface extending essentially along the direction of the center axis from a respective border section of the deflecting bottom surface to the rim surface.

2. The piston top structural unit of claim 1, wherein one or more of the area of lowest positions and the deflecting bottom surface are configured as planes.

3. The piston top structural unit of claim 1, wherein the deflecting bottom surface transitions into one of the rim surface and a step-like transition that is formed between the deflecting bottom surface and the rim surface.

4. The piston top structural unit of claim 1, wherein at least one of the transitions between the deflecting bottom surface, the area of lowest positions of the piston bowl, the first side wall surface, the at least one second side wall surface, and the rim surface are provided with a curvature for forming a smooth transition.

5. The piston top structural unit of claim 1, wherein with respect to an opening area, which is surrounded by rim surface, the opening area extends up to about 50% of the size of the deflecting bottom surface.

6. The piston top structural unit of claim 1, further comprising:
a coolant guiding structure that is at least partly integrated into the piston top structural unit,
wherein the coolant guiding structure comprises an inner cooling chamber surface for forming a central cooling chamber that extends within a radial inner section of the piston top structural unit, wherein the inner cooling chamber surface at least partly follows an inclination of the deflecting bottom surface, thereby providing a material thickness between the inner cooling chamber surface and the deflecting bottom surface of essentially constant thickness in the respective section.

7. The piston top structural unit of claim 1, further comprising:
a coolant guiding structure that is at least partly integrated into the piston top structural unit,
wherein the coolant guiding structure comprises a peripheral cooling volume that is larger at a side where the deflecting bottom surface transitions into the rim surface than at a side where the area of lowest positions of the piston bowl is located.

8. The piston top structural unit of claim 1, further comprising:
a coolant guiding structure that is at least partly integrated into the piston top structural unit,
wherein the coolant guiding structure comprises one or more of a peripheral cooling channel surface for forming a peripheral cooling chamber that provides a larger cooling volume at the side where the deflecting bottom surface transitions into the rim surface than at the side where the area of lowest positions of the piston bowl is located, and wherein in particular the peripheral cooling channel surface comprises one or more in particular radially extending rib structures, and
cooling bores forming shaker chambers, in which coolant moves axially during engine operation.

9. The piston top structural unit of claim 1, wherein the piston crown structure is configured to provide for a weight balancing in the direction of the inclination in particular by providing hollow chambers at the side where the deflecting bottom surface transitions into the rim surface.

10. An internal combustion engine comprising:
a cylinder unit;
at least one inlet valve associated with the cylinder unit;
at least one outlet valve associated with the cylinder unit; and
a piston arranged within the cylinder unit and having a piston top structural unit according to claim 1 and a piston skirt unit.

11. The internal combustion engine of claim 10, wherein the deflecting bottom surface extends along an inclination axis being substantially inclined with respect to a radially extending axis such that the at least one inlet valve is positioned closer to the area of lowest positions than the at least one outlet valve or vice versa.

12. The internal combustion engine of claim 10, wherein the piston skirt is configured to provide for a weight balancing in the direction of the inclination in particular by one of providing at least one hollow chamber at the side where the deflecting bottom surface transitions into the rim surface and by providing additional weight at the side where the area is located.

13. The piston top structural unit of claim 2, wherein the second border section of the area of the lowest positions extends linearly between two end points.

14. The piston top structural unit of claim 13, wherein the first border section of the area of the lowest positions connects the two end points in a curved manner such as a segment of a circle or the like.

15. The piston top structural unit of claim 1, wherein the deflecting bottom surface is configured to be inclined with respect to the center axis and a plane orthogonal to the center axis.

16. The piston top structural unit of claim 2, wherein the deflecting bottom surface transitions into one of the rim surface and a step-like transition that is formed between the deflecting bottom surface and the rim surface.

17. The piston top structural unit of claim 4, wherein the rim surface comprises one or more valve pocket forming recesses.

18. The piston top structural unit of claim 5, wherein an extension of the deflecting bottom surface in a radial direction with respect to the center axis from the opening area to the rim surface is in the range from about 20% to about 100% of a diameter of the opening area.

19. The internal combustion engine of claim 10, wherein the deflecting bottom surface of the piston top structural unit transitions into one of the rim surface and a step-like transition that is formed between the deflecting bottom surface and the rim surface.

20. The internal combustion engine of claim 10, wherein the piston top structural unit includes at least one of the transitions between the deflecting bottom surface, the area of lowest positions of the piston bowl, the first side wall surface, the at least one second side wall surface, and the rim surface being provided with a curvature for forming a smooth transition.
